(19) United States
(12) Patent Application Publication
(10) Pub. No.: US 2010/0260606 A1
(43) Pub. Date: Oct. 14, 2010

(54) NAUTICAL VARIABLE-PITCH PROPELLER

(75) Inventor: Massimiliano BIANCHI, Milano (IT)

Correspondence Address: LUCAS & MERCANTI, LLP, 475 PARK AVENUE SOUTH, 15TH FLOOR, NEW YORK, NY, 10016, US

(73) Assignee: MAX PROP S.R.L., Milano (IT)

(21) Appl. No.: 12/755,141

(22) Filed: Apr. 6, 2010

Related U.S. Application Data
(63) Continuation-in-part of application No. PCT/IT2009/000154, filed on Apr. 8, 2009.

(30) Foreign Application Priority Data
Apr. 28, 2009 (IT) MI2009A000719

(51) Int. Cl. B64C 11/06

(52) U.S. Cl. 416/147

(57) ABSTRACT

Nautical variable-pitch propeller of the type comprising a hub driven by a drive shaft, an outer case externally constrained to the hub, and one or more blades, wherein each blade is constrained to the outer case freely to rotate around the (Y-Y) axis of an own shaft, the afore said outer case making each blade to rotate around the axis (X-X) of the hub, as well as a device for regulating the angular position of the blade around the (Y-Y) axis of its own shaft relatively to the hub. Advantageously, the regulating device comprises at least one moving member and means for transmitting movement from the moving member to the shaft of the blade, according to at least two different laws of motion transmission.

### CROSS-REFERENCE TO RELATED APPLICATIONS

This application claims the benefit of priority from Italian Patent Application No. IT/MI2009A000719, filed Apr. 28, 2009 and PCT Application No. PCT/IT2009/000154, filed Apr. 8, 2009. This application is also a continuation-in-part of PCT/IT2009/000154. The contents of each application are incorporated herein by reference.

### BACKGROUND OF THE INVENTION

The present invention refers to a nautical propeller provided with multiple pitch regulations comprising a hub, a drive shaft, an outer case constrained to the hub, and one or more blades constrained to the outer case such that to be able to rotate around their own shaft. The outer case of the propeller is able to make to rotate each blade around the hub axis. Further, the propeller provides a device for multiple regulation of the angular position of at least one blade around its own shaft relatively to the hub.

### KNOWN PREVIOUS ART

The devices of the known art provide different means for regulating the propeller pitch that can be both mechanical and hydraulic. Such devices could be driven by both automatic and manual systems, and could have both continuous and discrete regulations. Patent WO-A-90/11221, in the name of Marine Propeller SRL, describes a manually regulated variable-pitch propeller provided with a central hub, an outer case having an annular shape coaxial with the central hub around which it could relatively rotate, with blades able to rotate around both their own axis and the pinion axis, a device for manual regulating the propeller pitch. The central hub is provided with a pinion engaging with the other component of the crown wheel and pinion, that is the crown wheel, placed at the shaft end of each blade. Every propeller has one more constraint, rotatable with the outer propeller body thanks to which it is made to rotate around the hub axis. When the outer propeller body is rotated relatively to the central hub, every blade is subjected to a rotation both around the axis of the central hub, because of the constrain with the outer propeller body, and around its own axis because of the claw clutch of the crown wheel placed at every blade base, with the pinion rigidly constrained to the propeller hub. The manual regulating device of such a propeller, coupling the outer case to the hub, provides a fixed coupling with the outer case and a decoupling device from the central hub used during the regulating step of the propeller pitch.

Variable-pitch propellers are known as well, wherein the regulation of the propeller pitch may be obtained, during the boat motion too, by a servo-control that, activated by the operator, is able to force a controlled rotation of a crown wheel, coaxial with the propeller hub and rotatably mounted thereon, engaged with the pinion of which every blade shaft is provided with.

For example, the European Patent EP-A-0328966 in the name of BIANCHI S.r.l., teaches how to realize a variable-pitch propeller wherein a fluidic operated ram induces the shift of a toothed sleeve that, conveniently shaped, adapted to cause the controlled rotation of a convenient annular crown wheel, rotationally constrained to the propeller hub. The annular crown wheel, in its turn, by a predefined number of teeth, engages the pinions integral with the propeller blade shafts. The ram manually operating causes the crown wheel and pinions rotation, thereby provoking the incidence angle variation of the blades themselves, that is the propeller pitch.

One of the drawbacks in such propellers of the known art, most of all in case of manually regulated propellers, is that for obtaining a fine regulation of the propeller pitch, it is necessary to provide the crown wheel with a great number of teeth, which drives, by the corresponding pinions, the blade rotation around their pivot axis to the propeller hub. So, to obtain a good accuracy in the propeller pitch regulation, it is necessary to realize crown wheels with an extremely great number of teeth (for example 100-200 teeth), with the consequent difficulties of realizing such crown wheels, and the hard and slow regulation of such a pitch.

Another drawback of the adjustable and variable-pitch propellers of the known art is that it is not possible to carry out operations of rough regulations for the propeller pitch or operations of fine regulation of the same pitch, at operator discretion. Such problems assume more importance while the range of propeller pitch changing is increasing, and of the required regulation accuracy too.

One of the objects of the present invention is then to realize an adjustable and variable-pitch propeller not presenting the above reported drawbacks of the known art.

It has to be outlined that the propeller pitch, obtained by the afore said manual or aided regulation, may be either the base propeller pitch, for example of a propeller with an automatically variable-pitch, that is for example the one described in WO-A-2008/075187 (in the name of MAX PROP S.r.l.), or the operator-fixed pitch, during the motion too, for example by the device described in EP-A-0328966, or the base propeller pitch of the type described in U.S. Pat. No. 4,140,434, in the name of Massimiliano Bianchi.

It is therefore an object of the present invention to provide an adjustable and variable-pitch propeller wherein it could be possible to carry out an extremely accurate regulation of the propeller pitch (fine regulation), without necessarily having to recourse to mechanical parts difficult to realize and without requiring long times for its regulation.

A further object of the present invention is to realize a propeller wherein it is possible to regulate the propeller pitch both in rough mode and in fine mode, at operator discretion, in an extremely simple manner.

It is finally another object of the present invention to provide a nautical propeller with adjustable and variable pitch, that is simple and effective in regulation and at the same time that it is not complex to realize.

### SUMMARY OF THE INVENTION

These and other objects are obtained by the adjustable and variable-pitch propeller according the first independent claim and the following independent claims.

The nautical variable-pitch propeller, according to the present invention, comprises a hub driven by the drive shaft, an outer case externally constrained to the hub, and one or more blades. Each blade is constrained to the outer case freely to rotate around the axis of its own shaft. The outer case is able to make to rotate each blade around the hub axis, other than to hold the blades constrained to the propeller. Further the propeller is provided with a mechanical device for regulation of the angular position of at least one blade around the axis of its own shaft relatively to the hub. Advantageously the regulating device comprises at least one moving member and means for transmitting movement from at least one moving member to the shaft of at least one blade, according to at least two different laws of motion transmission.

The presence of at least two different laws (functions) connecting the motion law of the moving member to the motion law of the blade shaft, provides the operator not only a higher flexibility in pitch regulation, but furthermore it aids the fine, or accurate, regulation obtaining, without the need of using complex or difficult to realize mechanisms.

This device in fact may allow to carry out a regulation of the propeller pitch in more steps, starting from a first rough regulation, according to one and/or the other of the at least two laws of motion transmission, and then carrying on with one or more fine regulations for a subsequent and more accurate pitch regulation, thanks to the discrete application, or preferably in cascade, of such at least two laws of motion regulation.

For example, as the person skilled of the art may deduce, by a first motion law it will be possible to regulate the angular position of the blade shafts according to multiples of a first angular range, and with the second law of motion transmission, it will be possible to regulate the same shafts according to multiples of a second angular range, different and eventually shifted relatively to the first.

According to a preferred aspect of the present invention, the mechanical device for regulating the pitch comprises at least two moving members, operable separately and/or jointly one relatively to the other, and two corresponding kinematic systems for transmitting motion from the moving members to the blade shaft (or the shafts of the blades), each one according to its own law of motion transmission, being different from one to another.

Such two regulating kinematic systems may be conformed to provide, at the operating of the two corresponding moving members, two different angular displacements of the propeller blade (or blades), such that the propeller pitch regulation may proceed with high accuracy, both when such kinematic systems are displaced, according to a preferred aspect of the invention, in cascade, and on the other hand when they are displaced so that to separately operate on the blade (or blades).

For example, in a preferred embodiment of the present invention, the afore said kinematic systems for transmitting the motion from the moving members to the propeller blade shaft may comprise two different toothed couplings, with a different tooth number, allowing the moving member rotation, and then the corresponding kinematic chains connecting the moving members from the blade shaft, or the shafts of the blades, of the propeller, according to different angular ranges, such that the operating in cascade of the two moving members causes an extremely accurate regulation of the pitch.

### BRIEF DESCRIPTION OF THE DRAWINGS

For purposes of illustrations only, and thereby absolutely not limitative, some embodiments of the present invention will be provided with reference to the accompanying drawings, in which:

FIG. 1 is a partial and functional view of a propeller in longitudinal section at the hub axis, according to a possible embodiment of the present invention;

FIG. 2 is a partial and functional view of a propeller in longitudinal section at the hub axis, according to a possible embodiment of the present invention, provided with optional elastic means;

FIG. 3 is a partial and functional view of a propeller in longitudinal section at the hub axis, according to a further embodiment of the present invention; and

FIGS. 4 and 4b are respectively a partial schematic side view, representing a check nut of the drive shaft, and a front schematic view of a propeller, without the check nut of the drive shaft, according to a particular aspect of the present invention.

FIG. 5 is a partial view of a propeller in longitudinal section at the hub axis, according to a possible embodiment of the present invention, provided with graduated scales for setting the propeller pitch.

### DETAILED DESCRIPTION OF SOME EMBODIMENTS OF THE PRESENT INVENTION.

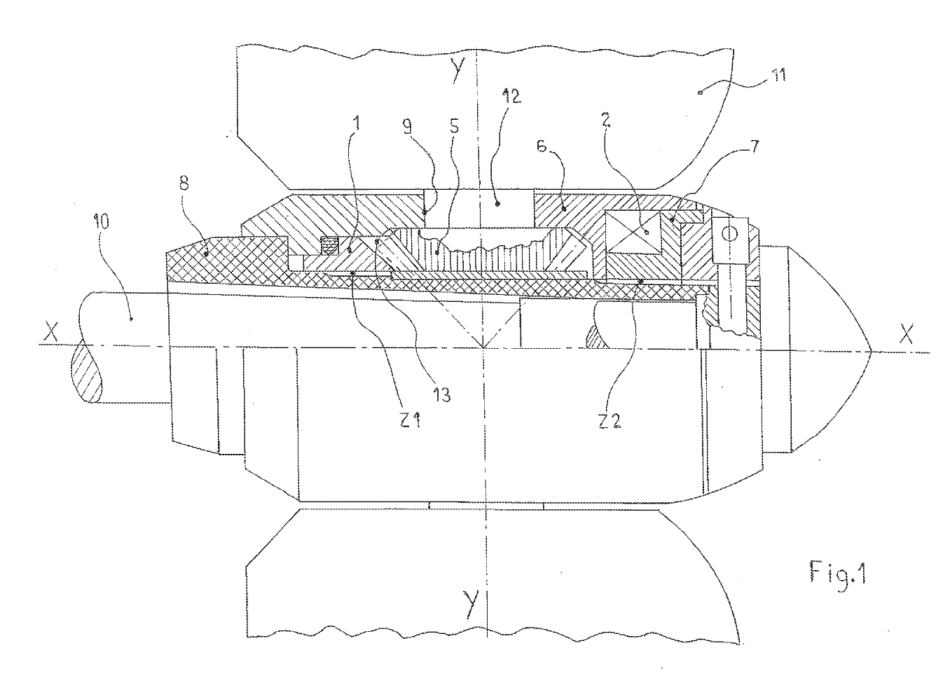

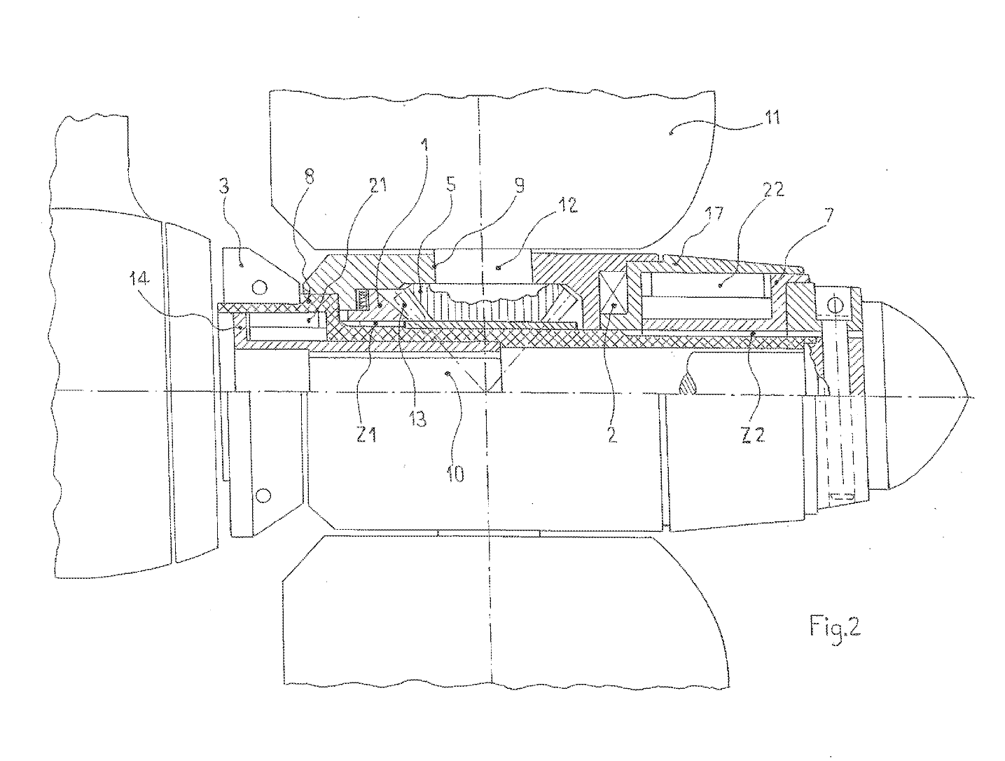

FIGS. 1 and 2 represent two different embodiments of a nautical variable-pitch propeller according to the characteristics of the present invention.

Referring first to the embodiment shown in FIG. 1, the propeller is comprised mainly of a hub 8 composed by an approximately cylindrical shaped body directly or indirectly coupled to a drive shaft 10, from which it receives the rotary motion, and a plurality of blade 11 provided with a corresponding shaft 12, that are revolvingly constrained to the hub 8 around both their own shaft axis 12, and the axis (propeller axis X-X) of the same hub 8, thanks to a case 6 receiving the rotary motion from the hub, as well as a mechanical device 1, 2, 5, 6, 7, 9, 13, Z1, Z2, for regulating the angular position of at least one blade 11 around its own shaft 12 relatively to the afore said hub 8.

The coupling between the hub 8 and the drive shaft 10 may occur in a plurality of methods, according to a known art, as for example by a spline connection, bayonet base, by clamping screws, interference, etc. It has to be observed that elastic means of different kinds may be comprised too in the coupling between the hub 8 and the drive shaft 10, interposed between the latter, as springs, synthetic joint, etc., herein not represented.

As afore said, each blade 11, in the embodiment herein illustrated, is constrained to the hub 8 thanks to an outer case 6, or shell, presenting on its side surface a plurality of holes, each one being intended for housing the shaft 12 of a blade 11. In the preferred embodiment herein illustrated, each shaft 12 of the blades 11 is constrained to the outer case 6 by a constraint 9 allowing the only rotation of the shaft 12, and then of the corresponding blade 11, around its own axis Y-Y. Further, the blades 11 are likewise constrained necessarily to the outer case 6 such that the potential translating movements of the blades 11 along the propeller axis X-X are opposed by such a further constraint. In this way, when the hub 8 is rotated by the drive shaft, the outer case 6 may make to rotate each blade 11 around the propeller axis X-X, in case wherein the hub 8 too is rotationally integral with the outer case 6.

It has to be noticed that the constraint 9 for the only rotation between each shaft 12 and the case 6 may be realized in different ways known in the art, as for example by a simple contact between the shaft 12 and the corresponding hole of the case 6, or by using a bearing interposed between the shaft 12 and the hole of the case 6, etc.

The case 6, as known in the art, has preferably a substantially cylindrical shape, it may be realized in two or more semi-shells reciprocally laterally attached, and is displaced around the hub 8, to which alternatively it could be constrained integrally, when it would be necessary to transmit the motion of the drive shaft 10 to the blades 11, or rotatably, relatively to the same hub 8, when, as it will be described, it would be necessary to regulate the pitch of the blades 11.

Further, each shaft 12 of the blades 11 is provided with a pinion 5, having the function of allowing the controlled rotation of the corresponding blade 11, and optionally preventing too, because of countering parts, the blades 11 from axially releasing from the case 6.

The afore said mechanical device for regulating the angular position of at least one blade 11 around its own shaft 12 relatively to the hub 8 advantageously comprises, according to the present invention, at least one moving member 1, 7, intended for being directly or indirectly activated by the operator, and for transmitting the motion, by corresponding transmission means Z1, Z2, 2, 5, 6, 9, 13, to at least one shaft 12 of the blades 11, according to at least two different laws of motion transmission.

It has to be observed that herein and afterwards with the term “law of motion transmission” is intended such a function relating the displacement of a determined operating point of the moving member with the displacement of the corresponding shaft 12, or the corresponding shafts 12, of the blades 11.

Specifically, in the herein illustrated embodiment, the regulating device comprises a first substantially annular member 1, axially coupled to the hub 8, and provided with a peripheral crown wheel 13 engaging the pinion 5 of the shaft 12 of at least a blade 11, as well as a second substantially annular member 7, coaxially coupled to the hub 8 and constrained to the outer case 6, thanks to a further toothed coupling 2, so that to can transmit a rotary motion to the latter.

Because the relative rotation of the annular members 1 and 7 relatively to the hub 8 causes, thanks to the kinematic systems 2, 6, 13, 15 afore mentioned, the angular displacement of the blade (or blades) 11, such annular members 1 and 7, that can be manually or by a servo-control operated once released from the corresponding toothed couplings Z1 e Z2, constitute the afore said first and second moving members 1 and 7.

In the embodiment shown in the figures, the peripheral crown wheel 13 of the first annular member 1 engages contemporaneously the pinions 5 of the shafts 12 of every blades 11, and similarly the outer case 6, rotationally integral with the second moving member 7 thanks to the coupling 2, is constrained to every shafts 12 of the blades 11, such that the possible propeller pitch regulation, that is the angular displacement of the blades 11 around their corresponding axis Y-Y, happens in unison.

In the preferred embodiment of the present invention herein described, both the first annular member 1, and the second annular member 7, are respectively removably constrained to the hub 8 by two different toothed couplings Z1 and Z2, such that their rotation around the hub may happen only when the member 1 and/or 7 to be operated is firstly disengaged, from the corresponding toothed coupling Z1 or Z2.

In the propeller of FIG. 1, such a disengagement from the corresponding toothing Z1 and Z2, and then from the hub 8, may happen contemporaneously or separately for the two members 1 and 7, preferably by the partial disassembly of the stern spinner, thereby to allow the relative shift of the assembly comprising the blades 12, the case 6 and the moving members 1, 7, until the latter are not coupled any more to the hub 8, and then free to rotate, relatively to the latter, around the axis of the propeller X-X.

Then the propeller herein described, the toothed couplings Z1 and Z2 have to be such to allow the disengage of the members 1 and 7 from the hub 8, however without allowing the disengage of the crown wheel 13 from the pinions 5 of the blades 11 and of the member 7 from the outer case 6, respectively.

In such a way, once the members 1 and 7 are released from the hub 8, the rotation of the second moving member 7 causes, thanks to the coupling 2, the corresponding rotation of the outer case 6, that in its turn rotates the blades 11 around the propeller axis X-X, whereas the rotation of the first moving member 1 causes the corresponding rotation of the crown wheel 13 and then, by the pinion 5, of the shafts 12 of the blades 11 around the axis Y-Y of the same shafts 12.

It has to be observed that, thanks to the perpetual clutching of the crown wheel 13 with the pinion 5, leaving the first moving member 1 fixed, and then the crown wheel 13, while the second moving member 7 is rotating, the rotation of the shafts 12 around the axis X-X causes, just because of the clutching of the pinions 5 with the crown wheel 13, in this case fixed, the corresponding rotation of the shafts 12 around their own axis Y-Y.

Then, the operating in cascade of the two moving members 1 and 7 of the propeller in FIG. 1, causes the corresponding rotation of the blades 11 relatively to their axis Y-Y, both when the second moving member 7 is operated, and when the first moving member 1 is operated.

It has to be observed that, in the embodiment herein illustrated, the displacement extent of the members 1 and 7, that is their angular position, once their operating is finished, is determined by the geometry Z1 and Z2 of the toothed couplings (or toothing). These latter in fact allow such members 1 and 7 to move only by amounts determined by the dimensions (and then the number) of the corresponding teeth, being necessary a re-clutching of the moving members 1, 7 over the corresponding toothed couplings Z1 and Z2, at the conclusion of their operating.

The toothed couplings Z1 and Z2, defining in this case the possible displacements of the moving members 1 and 7, as well as the kinematic systems comprising the pinion 5 of each shaft 12, the crown wheel 13 of the moving member 1, the toothed coupling 2 between the moving member 7 and the case 6 respectively, as well as the case itself 6, constitute therefore the motion mode of such shafts 12 just when the moving members 1 and 7 are operated.

The peripheral crown wheel 13 of the first moving member 1, the pinions 5, the outer case 6 (maintained fixed), and the toothed coupling Z1 thereby constitute a first transmission kinematic system from the moving member 1 to the shafts 12 of the blades 11 and, similarly, the toothed coupling 2, the outer case 6, the crown wheel 13 itself (maintained fixed relatively to the hub 8 and engaged with the corresponding pinions 5) and the pinions 5, as well as the toothed coupling Z2, constitute a second transmission kinematic system of the motion from the moving member 7 to the shafts 12 of the blades 11.

It has to be noticed that, referring to the afore said second kinematic system for motion transmission, the outer case 6 relating to the hub 8, as well as the toothed coupling (or toothing) Z2, constitute the means for rotating the shafts 12 of the blades 11 around the propeller axis X-X, whereas the toothed crown wheel 13, with the pinions 5, constitute the means for rotating the shafts 12 around their axis Y-Y, when the rotation of the shafts 12 themselves around the afore said axis X-X occurs.

The afore said motion transmission means Z1, Z2, 5, 2, 6, 13 of the propeller herein described define, thanks to their geometry, at least two different laws of motion transmission relating the displacement of each moving member 1 and 7 to the displacement of the shafts 12 of the blades 11, so that the operating of the two moving members 1 and 7 may provide a synergic operating of the shafts 12, for example allowing a high regulating precision of the angular position of such shafts 12, and then of the propeller pitch. As mentioned yet, such laws of motion transmission are such functions relating reciprocally the displacement of a determined operating point of the corresponding moving member 1, 7 to the displacement of the corresponding shafts 12; functions that, in this case, are relating reciprocally the rotation around the propeller axis X-X of the moving members 1, 7, to the rotation of the shafts 12 around their own axis Y-Y.

More particularly, as it will be evident for a person skilled in the art, the geometry of the toothed couplings Z1 and Z2, as well as of the crown wheel and pinions composed by the crown wheel 13 and the pinions 5 of the shafts 12 of the blades 11, substantially determine the afore said at least two different laws of motion transmission from the moving members 1, 7 to the shafts 12.

Usually, and preferably, the tooth number in the toothed couplings Z1 and Z2 are different to distinguish the afore said at least two laws of motion transmission.

For example, the fulfillment of the two toothed couplings Z1, Z2 with a different number of teeth, independently from the circumference whereon the toothing is realized, concurs to determine two different laws of motion transmission from the moving members 1, 7 to the pinions 5 of the blades 11.

In other words, in the particular embodiment of the invention herein shown, the toothing Z1 and Z2 determine, according to the corresponding number of teeth, the minimal angular range of displacement of the moving members 1 and 7, and then the minimal angular rotation range of the blades 11 around their corresponding axes Y-Y, the multiples of which establish the whole angular displacement of the blades 11. Thereby, for example, if Z1 presents 22 teeth and Z2 presents 23 teeth, the corresponding annular moving members 1 and 7 could rotate by angles that are respectively multiples of 2π/22 radians and 2π/23 radians, such that, by operating in cascade such members 1 and 7 would be possible, by the kinematic systems above described, to provide the shaft 12 of each blade 11 as many as 22×23=506 different regulation possibilities.

Generally speaking, it has so to be observed that one of the advantages of the present invention is provided by the possibility of an extremely accurate regulation of the propeller pitch, that is of the angular displacement of the shafts 12 of the blades 11, without the need of using pinions and crown wheel having a higher number of teeth. In fact in the embodiments herein described, as it will be evident, making two regulations in cascade of which the first by a regulating device having a number N of teeth, and the second having a number M of teeth, it is possible to obtain M adjustments for each of the N previously determined positions, so obtaining a number of possible regulations of N×M in view of a number of teeth of N+M.

At last it has to be noticed that any other coupling between the moving members 1 and 7 and the hub 8 allowing the moving members 1, 7 to change from a constrained position to a de-constrained position from the same hub 8 and allowing, in the constrained position, the relative controlled displacement of such members 1, 7 relatively to the hub 8, falls anyway within the inventive conception of the present invention.

In the embodiment herein described the moving members 1 and 7 are separately operable, that is there is no law relating the mutual positions induced by the operator. However, such a moving members, according to alternative embodiments of the present invention, herein not shown, may be reciprocally constrained such that the operating of a member affects also the motion of the other moving member or the other moving members. Further, the fulfillment of a propeller provided with only one or more moving members falls in the inventive conception of the present invention, where each one of them, thanks to the kinematic systems of motion transmission, are provided with the possibility of changing the law of motion transmission between the blade and the moving member itself. Of such kinematic systems of motion transmission, at least one may be provided with gear wheel couplings. Further, in the embodiment herein described, the moving members 1, 7 are two, they have annular shape and have circular motion, but they may be only one too, they may be straight sliders or generally be provided with kinematic systems for transforming a translatory motion in a rotary motion, and vice versa.

Referring now to FIG. 2, wherein similar reference numbers to those of FIG. 1 for similar propeller parts have been used, it has to be premised that, as afore mentioned, in other possible alternative embodiments according the present invention, at least one of the moving members and/or the motion transmission means may be provided with at least one elastic connection.

This kind of solution, illustrated by way of example in FIG. 2, may be derived from a propeller similar to that afore described, but provided with elastic connection means 21 and 22. In the propeller of FIG. 2, the elastic connection means 21 elastically disconnects the hub 8 from the drive shaft 10, such an elastic means 21 being conveniently constrained to an annular body 14, which is in its turn integral with the drive shaft 10. Such elastic connection means 21 acts as a protection against impacts, allowing the hub 8 to partially idly rotate around the shaft 10, by the elastic deformation of such an elastic means 21.

Similarly, the elastic connection means 22 elastically disconnects the moving member 7 from the outer case 6, elastically decoupling the two elements, by the toothed coupling 2 and the intermediate annular sleeve 17 interposition.

More in detail, the kinematic system for the motion transmission from the second moving member 7 to the shafts 12 of the blades 11 of the propeller in FIG. 2 comprises, interposed between the moving member 7 itself and the toothed coupling 2 from the outer case 6, an intermediate annular sleeve 17, that is rigidly constrained to the outer case 6 by the toothing 2 and it is further elastically constrained, such that there could be a partial relative rotation, from the moving member 7, by the afore said elastic connection means 22.

In this way, once the propeller has been mounted, after the operator carried out the pitch regulation, the elastic connection means 22, thanks to its deformability, allows the outer case 6 to partially rotate around the moving member 7, thereby causing both a rotation of the blades 11 around the axis X-X of the hub 8, and the rotation of the shaft 12 of each blade 11 around its own axis Y-Y, thanks to the crown wheel 13 and the pinions 5, thereby causing a continuous automatic changing of the propeller pitch (as for example described in WO-A-2008/075187). Further, such an elastic decoupling by the connection means 22, will aid the possible jerk mitigation during the boat motion.

In short, as afore mentioned, such elastic connections, that can be one or more than one if present, exercise different functions, relating to their arrangement in the propeller.

As described yet, for example, both elastic connection means 21 and 22 of the propeller in FIG. 2 have the function of protecting at least one blade 11 from accidental impacts against outer objects, allowing an elastic rotation of at least one blade 11 around the axis X-X of the propeller. It has to be outlined that, in case of impacts or jerks, from the rotation of the blade around the axis X-X of the propeller a blade rotation around its own axis Y-Y does not necessarily follow too, because in this case there is not a changing in the propeller pitch, but also an idle rotation of the whole propeller body around the drive shaft.

Alternatively, the elastic connection means 22 of the propeller in FIG. 2 may have the function of allowing the automatic regulation of the propeller pitch, that will change because of the hydrodynamic pressure exercised against the blades 11, because the hydrodynamic pressure, during the boat advance motion, may cause a rotation of the blades 11 around the axis X-X of the propeller, and then an angular displacement of the outer case 6 relatively to the hub 8, that, although countered by the elastic connection means 22, will generate the rotation of each blade 11 around its own axis Y-Y, thanks to the coupling of the crown wheel 13 with the pinion 5 of each blade 11, thereby obtaining a continuous change in the propeller pitch.

Referring to what afore reported, and particularly to FIG. 1, it is after described a process that an operator may conveniently follow to obtain the propeller pitch regulation.

The process for regulating the propeller pitch, according to an aspect of the present invention, may be executed rendering shiftable the outer portion of the propeller along the axis X-X, after at least the outer case 6, with the blades 11 and the regulating devices 1, 2, 5, 7, 13, Z1, Z2 of the angular position of the blades 11, that is of the propeller pitch, have been released from a stop, conveniently realized, having the purpose of impeding axial movements of the propeller by different clamps or blocks, as for example an engaging clutch, screw clutch, interfering clutch, by insertion of a pin, etc.

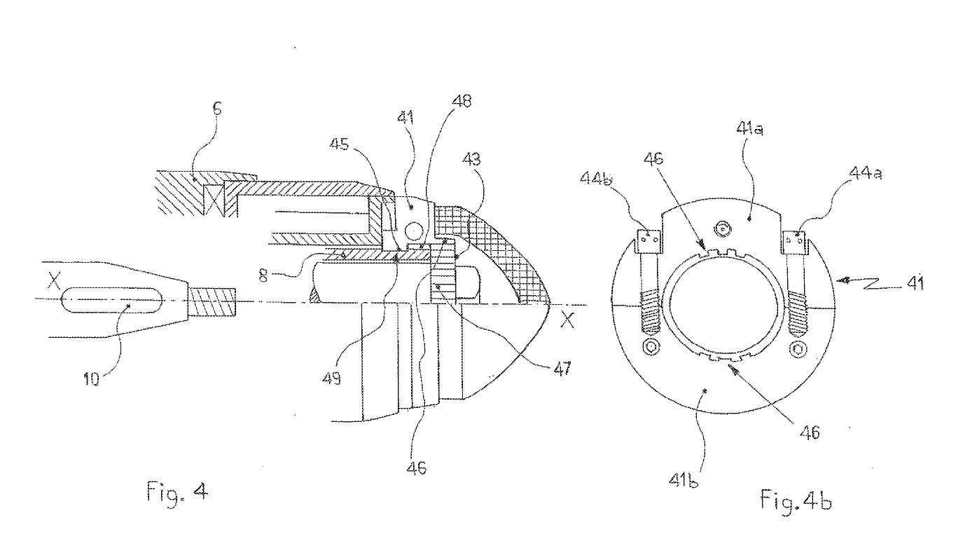

In FIG. 4 an example of possible embodiments of the propeller components coupling is schematically illustrated. Such an embodiment provides the drive shaft 10 to be internally coupled to the hub 8 by complementary grooves (spline connections), parallel to the axis X-X of the propeller, and respectively obtained from the outer surface of the shaft 10 and on the inner (coupling) surface of the hub 8, as well as by a nut 43 screwed at the ending, advantageously threaded, of the same shaft 10. Further, the outer case 6 is in its turn externally constrained to the hub 8 by a closing ring 41, composed in this case of two or more parts 41a, 41b reciprocally juxtaposed and clamped for example by screws 44a, 44b, that becomes integral with the hub 8, directly or by interposition of possible further means adapted to counter the axial movements of such a case 6 relatively to the hub 8.

More in detail, in the specific embodiment of FIG. 4, the ring 41, composed of two semi-rings 41a, 41b, is coupled to the hub 8, thanks to a profile 45, internally integral with the ring 41, engaging within a corresponding seat 49, obtained on the outer surface of the hub 8.

The profile 45, in the embodiment of FIG. 4, has an approximately annular shape, as it is annular the seat 49, realized as a circular groove, with its centre on the axis X-X of the propeller, over the side surface out of the hub 8.

More in general the coupling geometry between the ring 41 and the hub 8 may comprise one or more grooves 49 approximately displaced on planes perpendicular to the axis X-X of the drive shaft, so that, thanks to the engagement of the profile 45, the ring 41 is able to counter the translatory movements along the axis X-X of the same ring 41, and then of the outer case 6 of the propeller.

The clamping ring 41 may further present some toothing 48, 46, almost parallel to the axis X-X of the hub, integrally and rotationally coupling the afore said clamping ring 41 relatively to the hub 8 and the nut 43, in their turn advantageously provided with grooves.

Particularly, the nut 43 presents in fact some grooves 47 accommodating the toothing 46, and similarly the hub 8 may present similar grooves, not shown in the figure, to accommodate the toothing 48 of the clamping ring 41.

In this way, the clamping of the ring 41 integrally couples the nut 43, the hub 8, and the remaining propeller components.

Therefore, the propeller in FIG. 4 may be mounted only clamping the nut 43 over the thread of the ending portion of the shaft 10, represented in FIG. 4. Then the propeller assembling provides, after the externally mounting of the case 6, to mount two semi-rings 41a, 41b over the hub 8, so that to insert the profile 45 inside the groove 49 and to couple the toothing 48 and 46 respectively with the toothing obtained on the hub 8 and that 47 obtained on the nut 43. The further clamping of the nuts 44a, 44b to form a ring 41 completes the propeller mounting.

Thanks to the clamping type described, the forces acting on the outer case 6 of the propeller, along the axis X-X, that would aid a relative shift respect to the hub 8, are countered by the clamping ring 41 without directly acting on the clamping means of the hub 8 oh the drive shaft 10, comprising in this case the nut 43, but that can be composed of any other means adapted to hold the hub 8 to the drive shaft 10.

Further, the coupling of the toothing 46 with the complementary toothing 47, externally obtained on the nut 43, prevents the latter from rotating and unscrewing during the propeller operations. In fact, because of the integral constraint created between the ring 41 and the hub 8, the toothing 46 of the ring 41 necessarily rotates integrally with the hub 8 and then is opposing, thanks to its coupling with the toothing 47, to any relative rotation of the nut 43 relatively to the hub 8 and the shaft 10.

At last, the use of the clamping ring 41 entails an appreciable facilitation for the substitution of the afore said nut 43, in the assembling step, so that its type, the corresponding thread, as well as other its characteristics may be easily modified, without impacting the propeller assembling or its regulation.

After the propeller stop removal, for example composed of the ring 41, it is then possible to translate the case 6, with the blades 11 and the regulating device 1, 2, 5, 7, 13, Z1, Z2 relatively to the hub 8, to the point of de-constraining the moving members 1, 7 from the corresponding toothed couplings Z1 and Z2. At this point, it will be possible to locate the blades 11 in their “feathered” position, in order to establish a reference position starting from which it is possible to obtain an accurate regulation of the propeller.

After having determined which is the exact propeller pitch, that is the rotation angle of the blades 11 around their own axis Y-Y starting from the afore said “feathered” position of the same blades 11, it is possible, for example by a predetermined table, to determine which might be the corresponding clutching positions of the two moving members 1, 7 over the corresponding toothed couplings Z1 and Z2, and then the extent of their rotations around the axis X-X of the propeller.

At this point, a previously determined rotation of the first moving member 1 is carried out, until the latter will reach its desired clutching position with the toothing Z1. Such a rotation of the moving member 1 happens maintaining the outer case 6 fixed, so that to cause the rotation of the crown wheel 13 relatively to the latter, around the axis X-X, and then, by means of the pinion 5, to cause a first rotation of the shafts 12 of the blades 11 around their corresponding axis Y-Y.

Then, if it is necessary another regulation of the propeller pitch, not obtainable with the rotation only of the first moving member 1, it may be performed a rotation of the second moving member 7, to the point of reaching the latter too its calculated clutching position with the toothing Z2, which determines the relative rotation of the outer case 6, and of the blades 11, relatively to the axis X-X, and relatively to the crown wheel 13, maintained fixed and engaged with the pinion 5, so that to provide one more angular rotation, around the corresponding axes Y-Y, the shafts 12 of the blades 11. Such a further angular rotation, because of the different laws of motion transferring of the first kinematic system Z1, 5, 13 and the second kinematic system Z2, 2, 6, 5, 13, will cause angular changes in the position of every shaft 12 of the blades 11 around its own axis Y-Y, different from these previously obtained operating the first moving member 1, so that it is possible to obtain an extremely exact and accurate regulation of the propeller pitch.

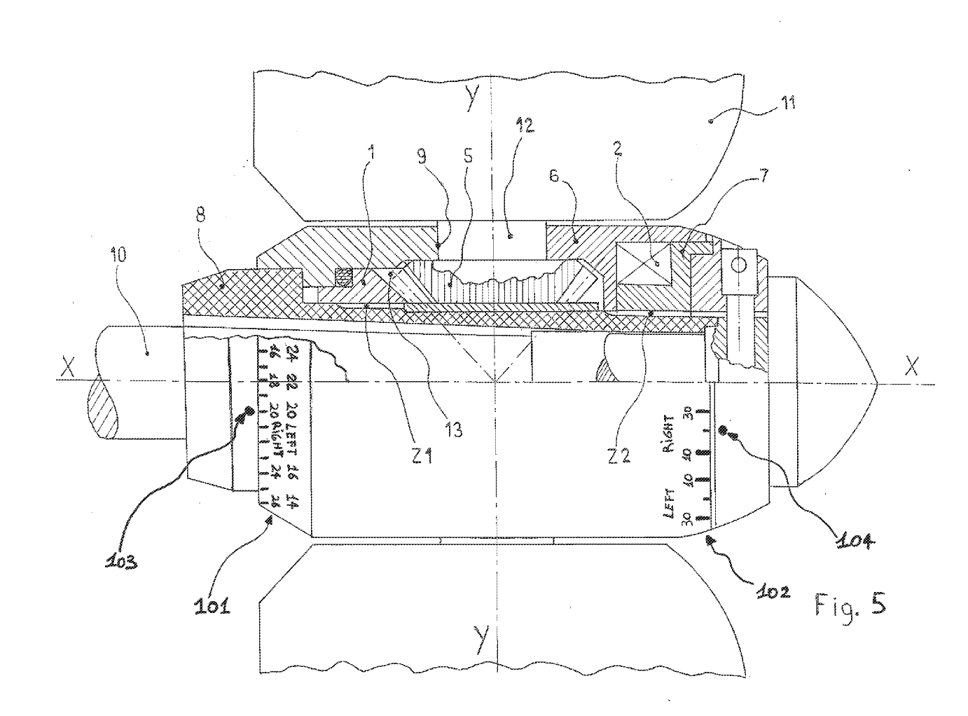

As an alternative, in a further possible embodiment of the propeller according to the present invention shown in FIG. 5 similar to that afore described, the angles of incidence of the blades (11), i.e. the propeller pitch, are stamped on the external surface of the propeller.

More in details, two graduate scales (101 and 102), respectively for the first and the second moving members (1, 7) are stamped, or attached, on the external propeller surface.

Each scale (101 and 102) is provided with a fixed reference point (103, 104) from which it is possible to set the angle of incidence that will be reached by the blades (11) after the rotation of the first and the second moving member (1, 7) both in the clockwise or the anticlockwise direction.

In this way, the user can regulate the propeller in a very simple manner by rotating the moving members (1, 7) of the desired value directly visible on the scales (101 and 102) without using the aforementioned table.

It has to be observed that, although it has been described the initial operating of the first moving member 1 and then of the corresponding kinematic system Z1, 5, 13 and then the operating in cascade of the second moving member 7 with the corresponding kinematic system Z2, 2, 6, 5, 13, it is obviously possible to obtain a similar propeller pitch inverting the afore described operation sequence.

The subsequent shift of the members 1, 7 of the blades 11 and the outer case 6 to the point of obtaining the re-clutching of the moving members 1, 7 on the corresponding toothing Z1, Z2 of the hub 8, will complete the manual regulation step of the pitch.

Such rotations and shifts having been executed, which, thanks for example to the different number of teeth of the toothing Z1 and Z2, allow to obtain an efficient and accurate regulation of the propeller pitch without the need of long regulating operations, the propeller is completely re-assembled, inserting again the afore said stop to prevent the shift along the axis X-X of the various components of the propeller itself.

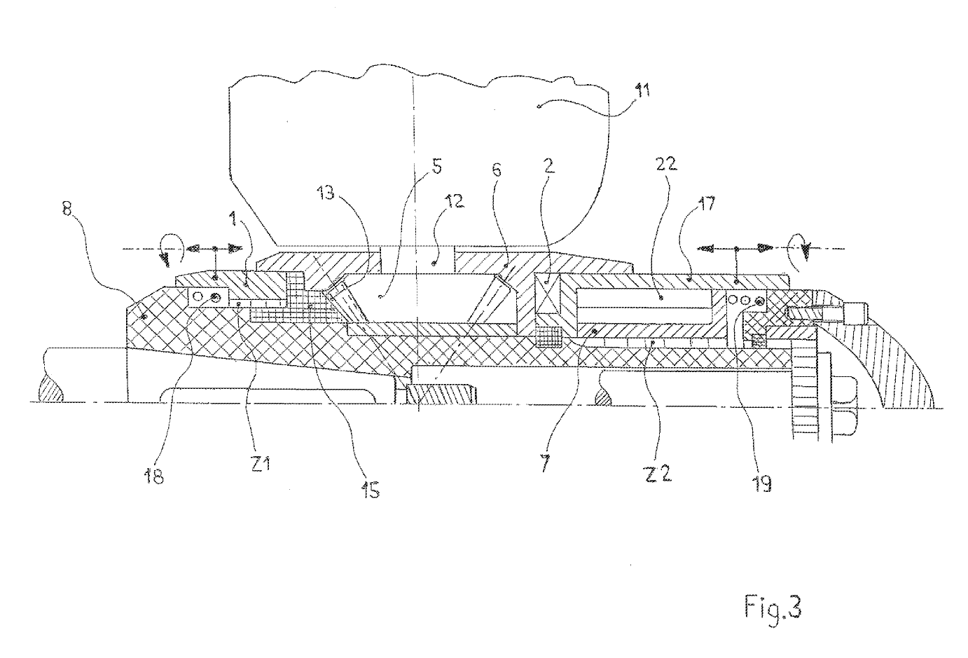

The embodiment schematically illustrated in FIG. 3, differently from the embodiments reported in FIGS. 1 and 2, while presenting strong similarities with the latter, will not require the operator to disassembly the propeller to be able to carry out the manual pitch regulation.

The propeller in FIG. 3, wherein similar components to those of the above described propellers are marked with the same numerical references, provides that, identically to the above said propellers, the first and the second moving members 1 and 7, 17 of the regulating device of the pitch are constrained in a not-permanent way to the hub 8 of the propeller, thanks to the possibility of realizing a relative shift along a direction parallel to the axis X-X of the propeller, by two toothing Z1 and Z2, and that their rotation around such an axis X-X of the propeller will cause, thanks to the corresponding kinematic systems of motion transmission Z1, 15, 13, 5 and Z2, 2, 6, 5, 13, two different laws of motion transmission, so that their operating in cascade, or eventually in series, or separately, may allow a simply, extremely accurate regulation of the propeller pitch.

However, differently from the propeller of FIGS. 1 and 2, the propeller herein described is shaped such that the moving members 1 and 7, 17 may shift along the axis X-X of the hub 8 of he propeller, without the need of disassembly the latter, so that the corresponding kinematic systems of motion transmission may be decoupled from the toothing Z1 and Z2 present on the hub 8, simply exercising an axial tractive force by the operator, directly or indirectly by a servo-control, on such moving members 1 and 7, 17.

More in detail, the first moving member 1, composed of an annular body coaxial to the hub 8, is integral with, not permanently, the same hub 8 thanks to the toothing Z1, for example provided with M teeth, and it is connected to the shafts 12 of the blades 11 thanks to a first kinematic system of motion transmission Z1, 15, 13, 5. Such a first kinematic system comprises, in addition to the toothing Z1, a ring 15, that is rotationally integral around the axis X-X with the first moving member 1, being coaxially mounted to the hub, just rotatably around the afore said axis X-X, and it is further peripherally provided with a toothed annular crown wheel 13, that is always engaged with the pinions 5 of the shafts 12.

The shape of the toothing Z1 is such that a shift of the first moving member 1, particularly along the axis X-X in direction of the prow, allows to decouple such a member 1 from the hub 8, without for this reason decoupling the two components 1 and 15. For countering such a shift and assuring a constant and permanent coupling of the member 1 with the hub 8, in absence of outer forces directly or indirectly exercised by the operator (by a servo-control), a torsion spring 18 is provided, opposing to the afore said shift along the axis X-X in direction of the prow.

The second moving member 7, 17 of the device for regulating the propeller pitch of FIG. 3, similarly to the first moving member 1, is not permanently integral with the hub 8 thanks to the toothing Z2, for example provided with N teeth, and it is connected to the shafts 12 of the blades 11 thanks to a second kinematic system of motion transmission Z2, 2, 6, 5, 13.

Such a second kinematic system comprises, in addition to the toothing

Z2, an outer case 6 of the propeller, a toothed coupling 2, rendering rotationally integral the case 6 itself with the second moving member, as well as the pinions 5 of the blades 11 and the crown wheel 13 (always engaged with the pinions 5 and fixed, during the regulation effected by such a second moving member 7, 17). It has to be observed that the toothed coupling 2 is dimensioned such that the outer case 6 and the second moving member 7, 17 are always coupled, also when the moving member 7, 17 is shifted relatively to the hub 8 along a direction parallel with the axis X-X of the propeller, in the stern direction.

Further, the toothing Z2 is shaped such that the shift of the moving member 7, 17 relatively to the hub 8 in the stern direction causes the moving member decoupling from the same toothing Z2.

For countering such a shift and assuring a constant and permanent coupling of the moving member 7, 17 and the toothing Z2 a torsion spring 19 is provided, opposing to the shift realized in the regulating step of the propeller pitch.

The second moving member 7, 17 of the propeller of FIG. 3, similarly to that in FIG. 2, is composed of an intermediate annular sleeve 17, that is constrained to an annular member 7 by an axial support of juxtaposed parts and by a means of elastic radial connection 22, so that the annular member 7, further not permanently constrained to the hub 8 by a toothing Z2, would be shiftingly integral (at least in one direction) with the annular sleeve 17 and results integrally rotating with the latter, around the axis X-X of the propeller, only after the force exercised by the means of elastic radial connection 22 has been overcome.

It has to be noticed that the means of elastic radial connection 22, as before better described, has both the function of mitigating possible impacts (jerks) which the propeller may be subjected to during the motion, and allowing an automatic regulation of the propeller pitch, during the boat motion.

Further, it has likewise to be observed that the toothing Z2 obtained on the hub 8 and the annular member 7 is specifically shaped to maintain the coupling of the member 7 with the hub 8 in a predetermined position assembly only, which are obtained or missed after a shifting along a direction parallel to the axis X-X of the same member 7.

For carrying out the manual regulation of the propeller pitch in FIG. 3 (base pitch) operating the moving member 1 it is necessary to shift the moving member 1 in the prow direction with a force sufficient to overcome the opposite force of the torsion spring 18. When the afore said shift of the moving member 1 in the prow direction has been carried out for a sufficient length, the decoupling between the toothing Z1 and the moving member 1 is obtained, the moving member 1 being shaped specifically for maintaining the coupling with the toothing Z1 in a predetermined position range only at the blocking position corresponding to the operating position. Once the decoupling between the moving member 1 and the toothing Z1 has been obtained, it is possible to rotate the moving member 1 around the X-X axis of the hub 8. Being the moving member 1 constrained to rotate integrally with the ring 15, and then the crown wheel 13 engaging thanking its own toothing with the pinions 5 of the shafts 12 of the blades 11, because of the shift rotation 12 the rotation of the moving member 1 causes the propeller pitch changing too.

To carry out the propeller pitch regulation operating the second moving member 7, 17 it is necessary to shift the moving member 7, 17 in the stern direction with a sufficient force to overcome the opposite one by the torsion spring 19. When the afore said translation of the moving member 7, 17 in the stern direction has been obtained for a sufficient length, the decoupling of such a member 7, 17 from the toothing Z2 is obtained. In this way, once such a decoupling has been obtained, it is possible to rotate the moving member 7, 17, except for elastic deformations by the elastic connection means 22, around the axis X-X of the hub 8. Being the moving member 7, 17 constrained (by the toothing 2) to rotate integrally to the outer case 6, which makes to rotate the shifts 12 around the axis X-X of the hub 8, the rotation of the moving member 7, 17 further entails the rotation around the axis X-X of the hub 12 of the blade 11, that is engaged to the crown wheel 13 by the pinions 5. In consequence, a rotation of the moving member 17 entails a changing of the propeller pitch too.

The implementation in cascade of the two moving members 1 and 7, 17, as afore described referring to the propellers in FIGS. 1 and 2, thanks in this case to the different number of teeth in the toothing Z1 and Z2, allows to obtain an extremely accurate regulation of the propeller pitch, simply and, in the propeller case in FIG. 3, as afore shown, without the need of disassembling the propeller itself.

1. Nautical variable-pitch propeller of the type comprising a hub driven by a drive shaft, an outer case externally constrained to said hub, and one or more blades, wherein each blade is constrained to said outer case freely to rotate around the Y-Y axis of its own shaft, said outer case making each blade to rotate around the axis (X-X) of said hub, as well as a device for regulating the angular position of at least one blade around the Y-Y axis of its own shaft relatively to said hub, wherein said regulating device comprises at least one moving member and means for transmitting movement from said at least one moving member to the shaft of at least one blade, according to at least two different laws of motion transmission.

2. Nautical propeller according to claim 1, wherein said regulating device comprises at least a first and a second moving member, operable separately and/or jointly one to each other, and in that said means for transmitting movement to said shaft of at least one blade comprise at least one first kinematic system for transmitting motion from said first moving member to said shaft, according to at least one first law of motion transmission, and at least one second kinematic system for transmitting motion from said second moving member to said shaft, according to at least one second law of motion transmission, said second law of motion transmission being different from said first law of motion transmission.

3. Nautical propeller according to claim 2, wherein said at least one first transmission kinematic system and/or said at least one second transmission kinematic system comprise one or more gear wheel couplings.

4. Nautical propeller according to claim 3, wherein said at least one first moving member comprises a first annular element coaxially and revolvingly constrained to said hub and said at least one first transmission kinematic system comprises a crown wheel and pinion which pinion is coaxially attached to the shaft of said at least one blade and which crown wheel is coincident with a peripheral edge of said annular element.

5. Nautical propeller according to claim 4, wherein said first annular element is removably attachable to said hub by a first toothed coupling, said first toothed coupling being part of said at least one first transmission kinematic system.

6. Nautical propeller according to claim 3, wherein said at least one second moving member comprises one second annular element axially and revolvingly constrained to said hub, and said at least one second transmission kinematic system comprises means for rotating the shaft of said at least one blade relatively around the axis (X-X) of said hub, as well as means for transmitting a rotation to said shaft around its own axis (Y-Y) during said rotation of the shaft relatively around the axis (X-X) of the hub.

7. Nautical propeller according to claim 6, wherein said second annular element is removably attachable to said hub by a second toothed coupling, said second toothed coupling being part of said second transmission kinematic system.

8. Nautical propeller according to claim 6, wherein said means to rotate the shaft of said at least one blade relatively around the axis (X-X) of said hub comprise a constraint for integrally rotation of said second annular element and said outer case.

9. Nautical propeller according to claim 6, wherein said means for transmitting a rotation to said shaft around its own axis (Y-Y) comprise a crown wheel and pinion having a fixed crown wheel that is coaxial to said hub, and engaged to a pinion coaxially integral with the shaft of said at least one blade.

10. Nautical propeller according to claim 4, wherein said crown wheel and pinion of said means for transmitting a rotation to said shaft around its own axis (Y-Y) of said at least one second transmission kinematic system coincides with said crown wheel and pinion of said at least one first transmission kinematic system.

11. Nautical propeller according to claim 5, wherein said first toothed coupling has a tooth number different from said second toothed coupling.

12. Nautical propeller according to claim 1, wherein at least one of said at least two different laws of motion transmission allows the rough regulation of the angular displacement of said blade around its own axis (Y-Y) of its shaft.

13. Nautical propeller according to claim 12, wherein the cascade application of said at least two different laws of motion transmission to said at least one blade allows a more accurate regulation of the angular displacement of said blade around its own axis (Y-Y) of its shaft.

14. Nautical propeller according to claim 1, wherein said at least one moving member is manually operated.

15. Nautical propeller according to claim 1, wherein said means for transmitting motion comprise means for transforming a translatory motion in a rotary motion and/or vice versa.

16. Nautical propeller according to claim 1, wherein at least one of said moving members and/or means for transmitting motion is provided with at least one elastic coupling.
